(19) United States
(12) Patent Application Publication
(10) Pub. No.: US 2015/0347000 A1
(43) Pub. Date: Dec. 3, 2015

(54) ELECTRONIC DEVICE AND HANDWRITING-DATA PROCESSING METHOD

(71) Applicant: KABUSHIKI KAISHA TOSHIBA, Tokyo (JP)

(72) Inventor: Yasuhiro OOKAWARA, Kunitachi Tokyo (JP)

(21) Appl. No.: 14/823,228

(22) Filed: Aug. 11, 2015

Related U.S. Application Data
(63) Continuation of application No. PCT/JP2013/060530, filed on Apr. 5, 2013.

(51) Int. Cl. G06F 3/0488; G06T 11/00; G06F 3/0482; G06K 9/00; G06K 9/22

(52) U.S. Cl. CPC G06F 3/04883; G06K 9/00402; G06K 9/222; G06F 3/0482; G06T 11/001

(57) ABSTRACT

According to one embodiment, an electronic includes a processor. The processor sets a first color for drawing strokes based on an operation of a user interface. The processor draws a first stroke, in response to handwriting input on a screen, in a second color different from the first color when the first color is identical to a color of a background on the screen. The processor draws the first stroke on the screen in the first color when a first time period associated with drawing the first stroke in the second color elapses.

### CROSS REFERENCE TO RELATED APPLICATIONS

This application is a Continuation Application of PCT Application No. PCT/JP2013/060530, filed Apr. 5, 2013, the entire contents of which are incorporated herein by reference.

### FIELD

Embodiments described herein relate generally to a technique for processing handwriting data.

### BACKGROUND

In recent years, various electronic devices, such as tablets, PDAs and smartphones, have been developed. Many of these types of electronic devices incorporate a touchscreen display in order to facilitate input operations by a user.

The user can instruct an electronic device to execute functions associated with a menus or an object displayed on the touchscreen display, by touching the menu or object using, for example, a finger.

However, many of existing electronic devices with the touchscreen display are directed to consumers who seek after operability of various media data including video and audio data, and therefore may not always be suitable to business activities, such as conferences, meetings and product development. Because of this, in business, paper notebooks are still widely used.

Electronic blackboard systems for conferences have also been developed recently.

Meanwhile, in the case of using paper pages of, for example, a notebook, a user may selectively use, for example, the colors of pens in accordance with content to be handwritten. Therefore, in order to enable an electronic device to easily handle handwriting data, it is necessary to enable various drawing styles to be utilized for creating a handwritten document.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the appearance of an electronic device according to an embodiment.

FIG. 2 is an exemplary diagram illustrating a cooperative operation between the electronic device and external devices, employed in the embodiment.

FIG. 3 is a diagram illustrating an example of a handwritten document handwritten on the touchscreen display of the electronic device according to the embodiment.

FIG. 4 is a diagram for explaining time-series data corresponding to the handwritten document of FIG. 3 and stored in a storage medium by the electronic device of the embodiment.

FIG. 5 is an exemplary block diagram illustrating a system configuration of the electronic device according to the embodiment.

FIG. 6 is an exemplary block diagram illustrating a functional configuration of a digital notebook application program executed by the electronic device of the embodiment.

FIG. 7 is an exemplary diagram for explaining an operation, performed by the electronic device of the embodiment, of drawing a stroke in a color different from the color set by a user operation.

FIG. 8 is a diagram for explaining a first example of an operation, performed by the electronic device of the embodiment, of returning the color of the drawn stroke to an original one.

FIG. 9 is a diagram for explaining a second example of the operation, performed by the electronic device of the embodiment, of returning the color of the drawn stroke to the original one.

FIG. 10 is an exemplary flowchart illustrating a procedure of drawing processing executed by the electronic device of the embodiment.

FIG. 11 is an exemplary diagram for explaining an operation of continuously shifting the colors of the stroke, performed by the electronic device of the embodiment.

### DETAILED DESCRIPTION

Various embodiments will be described hereinafter with reference to the accompanying drawings.

In general, according to one embodiment, an electronic device includes a processor. The processor sets a first color for drawing strokes based on an operation of a user interface. The processor draws a first stroke, in response to handwriting input on a screen, in a second color different from the first color when the first color is identical to a color of a background on the screen. The processor draws the first stroke on the screen in the first color when a first time period associated with drawing the first stroke in the second color elapses.

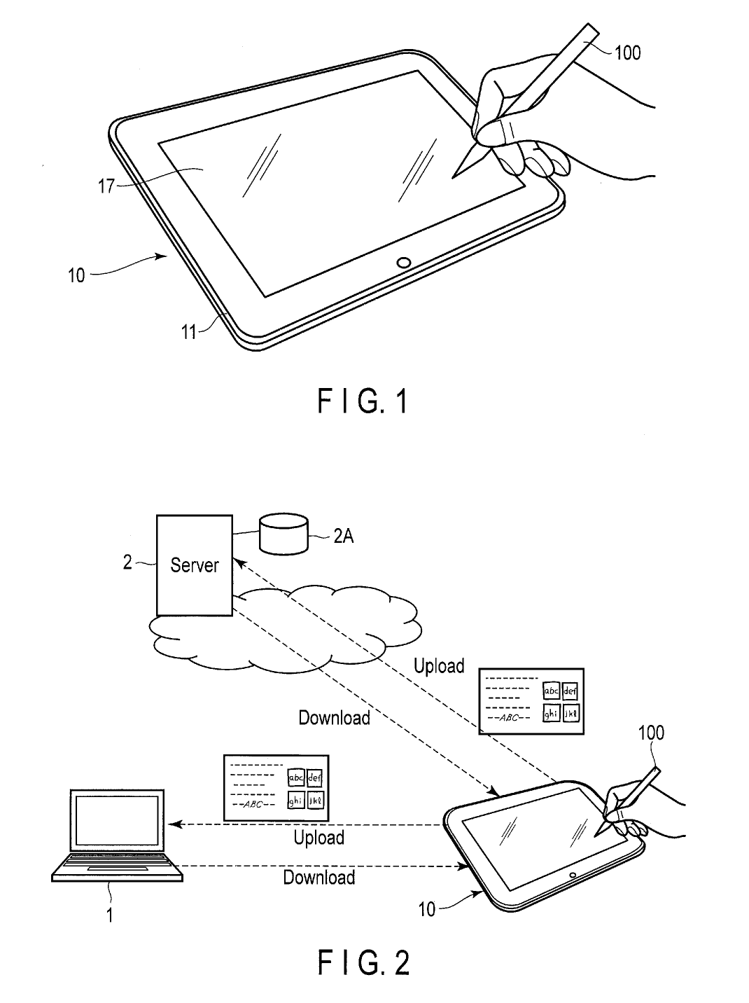

FIG. 1 is a perspective view showing the appearance of an electronic device according to an embodiment. The electronic device is, for example, a stylus-based portable electronic device that permits handwriting by a pen (stylus) or a finger. The electronic device may be realized as a tablet computer, a notebook computer, a smartphone, a PDA, or the like. In the following, it is assumed that the electronic device is implemented as a tablet computer 10. The tablet computer 10 is a portable electronic device also called a tablet or a slate computer, and includes a main body 11 and a touchscreen display 17 as shown in FIG. 1. The touchscreen display 17 is attached to the main body 11, superposed on the upper surface of the main body 11.

The main body 11 has a housing like a thin box. The touchscreen display 17 includes a flat panel display, and a sensor configured to detect the touch position of a stylus or a finger on the screen of the flat panel display. The flat panel display may be, for example, a liquid crystal display (LCD). As the sensor, an electrostatic capacitive touchpanel, an electromagnetic induction type digitizer, etc. can be used. In the embodiment, it is assumed that two types of sensors, that is, the digitizer and the touchpanel, are both built in the touchscreen display 17.

The digitizer and the touchpanel are each provided to cover the screen of the flat panel display. The touchscreen display 17 can detect not only a touch operation on the screen using a finger, but also a touch operation on the screen using a stylus 100. The stylus 100 may be, for example, an electromagnetic induction stylus. A user can perform a handwriting input operation on the touchscreen display 17, using an external object (the stylus 100 or a finger). During the handwriting input operation, the locus of motion of the external object (stylus 100 or finger) on the screen, that is, a handwritten stroke which is handwritten by the handwriting input operation (the locus of the handwritten stroke), is drawn in real time, whereby a plurality of handwritten strokes input by handwriting (the loci of the strokes) are displayed on the screen. The locus of motion of the external object while the external object is in contact with the screen corresponds to one handwritten stroke. A set of handwritten strokes corresponding to handwritten characters, marks, figures, tables, etc., that is, a number of loci (pen strokes), forms handwriting data. In the following, a handwriting stroke may be referred to simply as a stroke.

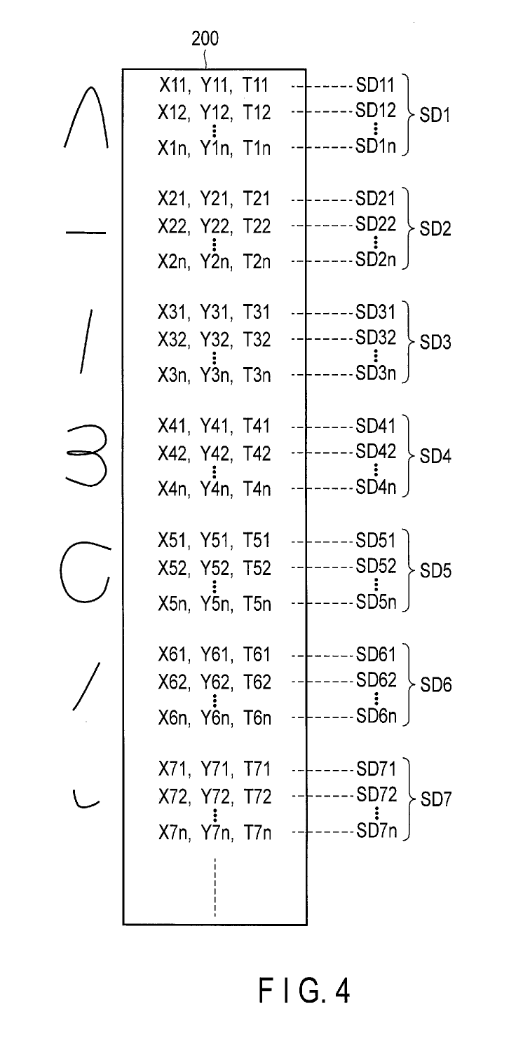

In the embodiment, the handwritten document is not stored as image data, but is stored as time-series data indicative of a sequence of coordinates corresponding to the loci of strokes and the order relationship between the strokes. As will be described later in detail referring to FIG. 4, the time-series data means the order in which the strokes were handwritten, and includes a set of stroke data items corresponding to respective strokes. In other words, the time-series data means a set of time-series stroke data items corresponding to the strokes. Each stroke data item corresponds to a certain one stroke, and includes a coordinate data sequence (time-series coordinate pairs) corresponding to respective points on the locus of the stroke. The order of the stroke data items corresponds to the order in which the strokes were handwritten, that is, the handwriting order of the strokes.

The tablet computer 10 can read arbitrary existing time-series data from the storage medium, and display, on a screen, a handwritten document corresponding to the time-series data, that is, a plurality of strokes represented by the time-series data. The strokes represented by the time-series data correspond to strokes input by handwriting.

The tablet computer 10 also has an editing function. The editing function can erase or move any of strokes or any of handwritten object portions (a handwritten character, a handwritten mark, a handwriting figure, a handwritten table, etc.) in the displayed handwritten document, in accordance with an editing operation performed by the user using an “eraser” tool, a range selection tool, or any other tool. Furthermore, any portion of the handwritten document selected by the range selection tool can be designated as a search key for searching the handwritten document.

In the embodiment, the time-series data (handwritten document) can be managed as one or more pages. In this case, the time-series data (handwritten document) may be divided into portions, each of which falls within one screen, thereby storing each portion of the time-series data as one page. Alternatively, the page size may be set variable. In this case, since the page size can be expanded greater than the screen size, a handwritten document greater than the screen size can be treated as one page. If the entire portion of one page cannot simultaneously be displayed on the display, the page may be reduced, or the display target portion of the page may be shifted by vertical and horizontal scrolling.

Each page can include, as well as a handwritten document (handwriting data), various types of content data, such as image data (still-image and video data), text data, audio data, and data generated by a drawing application. In other words, a handwritten document (handwritten page data) handled in the embodiment can include a plurality of media data items (handwriting data, image data, text data, audio data, data created by the drawing application, etc.). In this case, different layers may be assigned to the respective media data items included in the handwritten page data. The user can handwrite a stroke (a handwritten character, a handwritten mark, a handwriting figure, a handwritten table, etc.) on certain media data (also called content data).

FIG. 2 shows an example of a cooperative operation between the tablet computer 10 and external devices. The tablet computer 10 can operate in corporation with the personal computer 1 and a cloud. That is, the tablet computer 10 includes a wireless communication device, such as a wireless LAN, and can perform wireless communication with the personal computer 1. The tablet computer 10 can also perform communication with a server 2 on the Internet. The server 2 may be a server that performs online storage services and other various cloud computing services.

The personal computer 1 includes a storage device, such as a hard disk drive (HDD). The tablet computer 10 can transmit handwritten page data to the personal computer 1 via a network, thereby storing it in the HDD of the personal computer 1 (upload). To realize secure communication between the tablet computer 10 and the personal computer 1, the personal computer 1 may authenticate the tablet computer 10 at the start of communication. In this case, a dialog box prompting input of an ID or a password by the user may be displayed on the screen of the tablet computer 10, or the ID of the tablet computer 10 may be automatically transmitted from the tablet computer 10 to the personal computer 1.

As a result, even when the tablet computer 10 has a small storage capacity, it can handle a large number of handwritten pages or a large amount of handwritten page data.

Further, the tablet computer 10 can read one or more handwritten page data items from the HDD of the personal computer 1 (download), and can display the content of the handwritten page data (handwriting data, other various content data items) on the display 17 of the tablet computer 10. In this case, a list of thumbnails obtained by reducing a plurality of handwritten page data items may be displayed on the screen of the display 17, or one page selected from the thumbnails may be displayed with a normal size on the display 17.

Furthermore, the device accessed by the tablet computer 10 is not limited to instead of the personal computer 1, but may be the server 2 on the cloud that provides, for example, storage services, as is described above. The tablet computer 10 can transmit handwritten page data to the server 2 via the network, thereby storing it in a storage device 2A incorporated in the server 2 (upload). The tablet computer 10 also can read arbitrary handwritten page data from the storage device 2A of the server 2 (download), thereby displaying the content (handwriting data and other various content data) of the handwritten page data on the display 17 of the tablet computer 10.

Thus, in the embodiment, the storage medium for storing handwritten page data may be the storage device of the tablet computer 10, the storage device of the personal computer 1, or the storage device of the server 2.

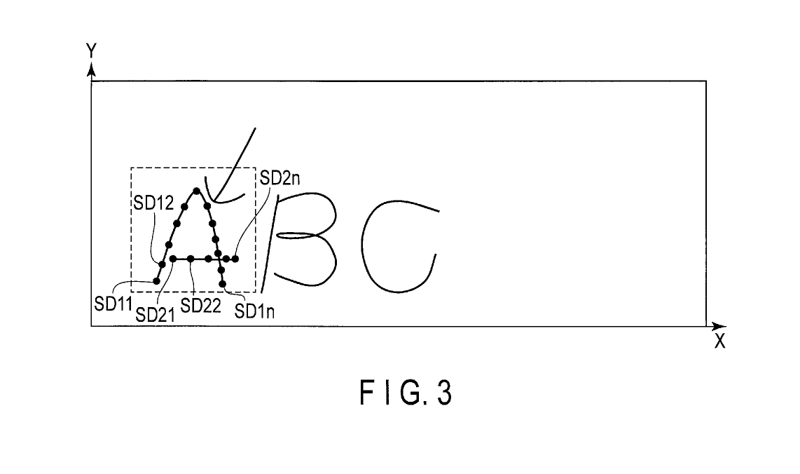

Referring then to FIGS. 3 and 4, a description will be given of the relationship between strokes (characters, marks, figures, tables, etc.) and the time-series data. FIG. 3 shows an example of a handwriting document (a handwritten character string) handwritten on the touchscreen display 17 using, for example, the stylus 100.

In a handwritten document, on a once written character, figure or the like, another character, figure, etc., may well be handwritten. In FIG. 3, it is assumed that a handwritten character string of “ABC” was made by handwriting characters “A,” “B” and “C” in this order, and then adding a handwritten arrow just near the handwritten character “A.” Handwritten character “A” is represented by two strokes (loci of “̂” and “-”) handwritten using, for example, the stylus 100, that is, two loci. The locus of the stylus 100 in the form of “̂,” which is initially handwritten, is sampled at, for example, regular intervals in a real-time manner. As a result, time-series coordinate data items SD11, SD12, . . . , SD1n corresponding to the “̂” stroke are obtained. Similarly, the locus of the stylus 100 in the form of “-,” which is subsequently handwritten, is sampled, whereby time-series coordinate data items SD21, SD22, . . . , SD2n corresponding to the “-” stroke are obtained.

Handwritten character “B” is represented by two strokes handwritten using, for example, the stylus 100, that is, two loci. Handwritten character “C” is represented by one stroke handwritten using, for example, the stylus 100, that is, one locus. Further, the handwritten arrow is represented by two strokes handwritten using, for example, the stylus 100, that is, two loci.

FIG. 4 shows time-series data (handwriting data) 200 corresponding to the document shown in FIG. 3. The time-series data 200 includes a plurality of stroke data items SD1, SD2, . . . , SD7. In the time-series data 200, stroke data items SD1, SD2, . . . , SD7 are arranged in a time-series manner in the order of handwriting, that is, in the order in which the strokes were handwritten.

In the time-series data 200, leading two stroke data items SD1 and SD2 indicate the two strokes of handwritten character “A.” Third and fourth stroke data items SD3 and SD4 indicate the two strokes of handwritten character “B.” Fifth stroke data item SD5 indicates the one stroke of handwritten character “C.” Sixth and seventh stroke data items SD6 and SD7 indicate the two strokes forming the handwritten arrow.

Each stroke data item includes a coordinate data sequence (time-series coordinate pairs) corresponding to one stroke, namely, includes pairs of coordinates corresponding to respective points on the locus of one stroke. In each stroke data item, pairs of coordinates are arranged in the order of handwriting. For instance, regarding handwritten character “A,” stroke data item SD1 includes a coordinate data sequence (time-series coordinate pairs) corresponding to respective points on the stroke locus in the form of “̂” of “A”, that is, n coordinate data items SD11, SD12, . . . , SD1n. Similarly, stroke data item SD2 includes a coordinate data sequence corresponding to respective points on the locus of a stroke indicative of “-” of handwritten character “A,” that is, n coordinate data items SD21, SD22, . . . , SD2n. The number of the coordinate data items may differ among different stroke data items.

Each coordinate data item indicates X- and Y-coordinates indicative of the corresponding point on a locus. For instance, coordinate data item SD11 indicates X-coordinate X11 and Y-coordinate Y11 corresponding to the initial point of the stroke “̂.” SD1n indicates X-coordinate X1n and Y-coordinate Y1n corresponding to the terminal point of the stroke “̂.”

Further, each coordinate data item may include time-stamp data T indicative of the time point at which the corresponding point was handwritten. This time point may be either an absolute time (for example, year, month, day, hour, minute, second) or a relative time with respect to a certain time point. For instance, an absolute time (for example, year, month, day, hour, minute, second) at which a stroke was started to be written may be added as time-stamp data to a stroke data item, and a relative time indicative of a difference from the absolute time may be added as time-stamp data T to each coordinate data item in the stroke data item.

The use of the time-series data including the time-stamp data T for each coordinate data item enables the temporal relationship between strokes to be expressed more precisely.

Moreover, data (Z) representing stylus pressure may be added to each coordinate data item. Yet further, a pen style (drawing style) may be added to each stroke data. The pen style represents the style of a handwritten stroke, for example, the color of a line (drawn locus), the line type (a solid line, a broken line), the line thickness, etc. The user can perform a handwriting input operation while changing the pen style to be used.

The time-series data 200 having such a structure as described with reference to FIG. 4 can represent not only the handwriting loci of individual strokes, but also the temporal relationship between the strokes. Accordingly, even when the tip of the handwritten arrow overlaps with or is located near handwritten character “A” as shown in FIG. 3, handwritten character “A” and the tip of the handwritten arrow can be treated as different characters or figures by using the time-series data 200.

Further, as described above, in the time-series data 200 of the embodiment, the order of arrangement of stroke data items SD1, SD2, . . . , SD7 indicates the order of the strokes of handwritten characters. For instance, the arrangement of stroke data items SD1 and SD2 indicates that firstly, the stroke of “̂” was handwritten, and then the stroke of “-” was handwritten. Therefore, even when the loci of the two handwritten characters are similar to each other, if the stroke order of the two handwritten characters are different from each other, the two handwritten characters can be discriminated as different characters.

Furthermore, as described above, in the embodiment, the handwriting data is not an image or character recognition result, and is stored as the time-series data 200 consisting of a set of time-series stroke data items. Therefore, handwritten characters can be handled regardless of the language of the handwritten characters. Thus, the structure of the time-series data 200 of the embodiment can be used in common in various countries of different languages in the world.

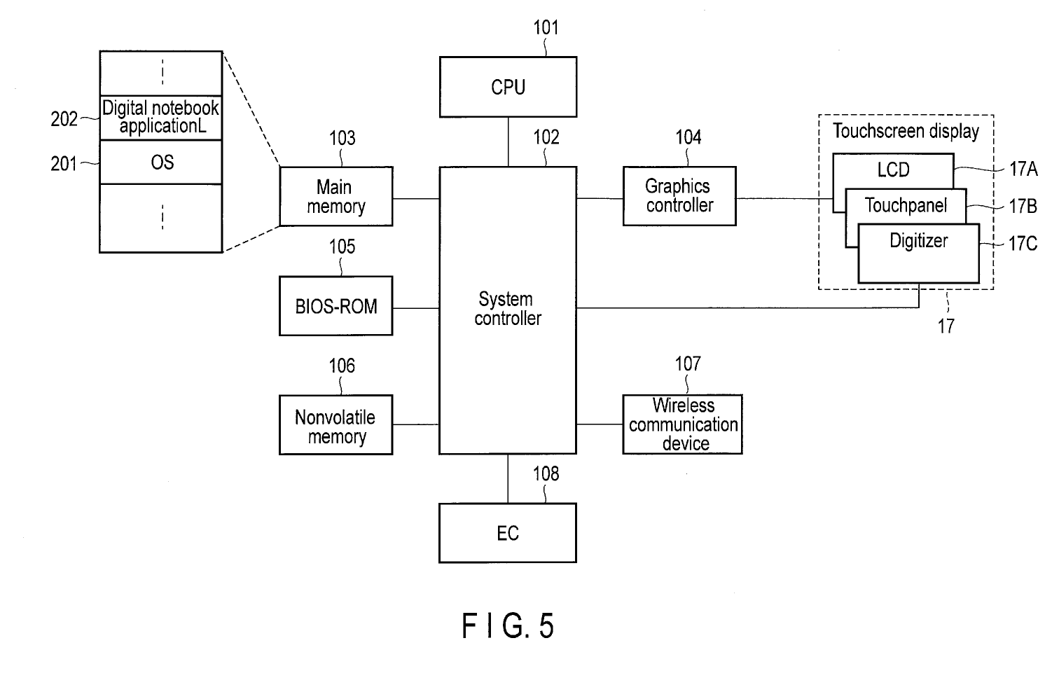

FIG. 5 is a diagram showing the system configuration of the tablet computer 10.

As shown in FIG. 5, the tablet computer 10 is provided with a CPU 101, a system controller 102, a main memory 103, a graphics controller 105, a BIOS-ROM 105, a nonvolatile memory 106, a wireless communication device 107, an embedded controller (EC) 108, etc.

The CPU 101 is a processor that controls the operations of various modules in the tablet computer 10. The CPU 101 executes various types of software loaded from the nonvolatile memory 106 as a storage device to main memory 103. The software includes an operating system (OS) 201 and various application programs. The application programs include a digital notebook application program 202. The digital notebook application program 202 has a function of generating and displaying the above-mentioned handwritten page data, a function of editing the handwritten page data, a function of recognizing a handwriting object (a handwritten character, a handwritten mark, a handwritten figure, and the like) in the handwritten page data, and a handwritten-document search function of searching for a handwritten document data item including a desired handwritten portion, or for a desired handwritten portion in a certain handwriting data item. The handwritten-document search function can perform both a handwriting search and a text search (character-string search). The handwriting search is a search method for searching for a stroke data group having a handwriting feature amount similar to that of a handwritten stroke group as a search key. The text search (character-string search) is a search method for searching for a handwritten character (a stroke data group) corresponding to a text as a search key (character code).

The CPU 101 also executes a basic input output system (BIOS) stored in the BIOS-ROM 105. The BIOS is a program for hardware control.

The system controller 102 is a device that connects the local bus of the CPU 101 to various components. The system controller 102 also contains a memory controller for controlling access to the main memory 103. The system controller 102 also has a function of executing communication with the graphics controller 104 via a serial bus of the PCI EXPRESS standards.

The graphics controller 104 is a display controller for controlling an LCD 17A used as the display monitor of the tablet computer 10. A display signal generated by the graphics controller 104 is sent to the LCD 17A. The LCD 17A displays a screen image based on the display signal. A touchpanel 17B and a digitizer 17C are provided on the LCD 17A. The touchpanel 17B is a pointing device of an electrostatic capacity type for performing inputting on the screen of the LCD 17A. The touch position of a finger on the screen, the movement of the touch position on the screen, and the like, are detected by the touchpanel 17B. The digitizer 17C is a pointing device of an electromagnetic induction type configured to perform inputting on the screen of the LCD 17A. The touch position of the stylus 100 on the screen, the movement of the touch position of the stylus on the screen, and the like, are detected by the digitizer 17C.

The wireless communication device 107 is configured to execute wireless communication, such as a wireless LAN or 3G mobile communication. The EC 108 is a one-chip microcomputer including an embedded controller for power management. The EC 108 has a function of turning on and off the tablet computer 10 in accordance with a user's operation of a power button.

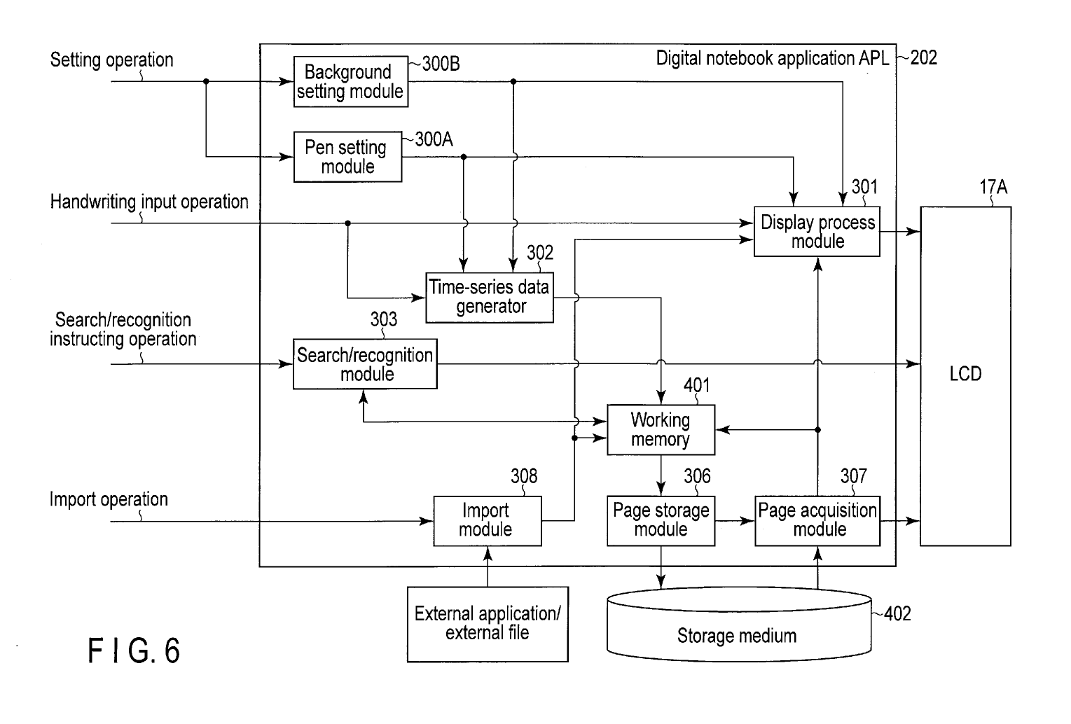

Referring then to FIG. 6, a description will be given of the functional structure of the digital notebook application program 202.

The digital notebook application program 202 is a WYSIWYG application that can handle handwriting data. The digital notebook application program 202 executes generation, display, editing, etc., of a handwritten document, using a coordinate data sequence (time-series coordinates) input by a handwriting input operation using the touchscreen display 17. The digital notebook application program 202 can also perform the above-mentioned handwriting search and text search. The digital notebook application program 202 can further perform handwriting recognition to convert a character handwritten on a handwritten document into a character code.

The digital notebook application program 202 includes, for example, a pen setting module 300A, a background setting module 300B, a display process module 301, a time-series-data generator 302, a search/recognition module 303, a page storage module 306, a page acquisition module 307 and an import module 308.

The touchscreen display 17 is configured to detect occurrence of events, such as “touch,” “move” (or “slide”), “release,” etc. “Touch” is an event indicative of that an external object has touched the screen. “Move” (or “slide”) is an event indicative of that a touch position has moved while the external object is touching the screen. “Release” is an event indicative of that the external object is detached from the screen.

The digital notebook application program 202 displays a note view screen on the touchscreen display 17 for enabling creation, viewing and editing of handwritten page data. The note view screen is a handwriting-enabled screen. The note view screen can display, for example, a plurality of pen icons, a range selection icon, and an eraser icon. Pen styles (drawing styles) are allocated to the pen icons, respectively. As aforementioned, each pen style is defined by a combination of the color of a line (drawn locus), the type of the line (a solid line, a broken line, etc.), the thickness of the line, the type of the tip of the pen (a ball point pen, a highlighter, a fountain pen, etc.), etc.

The pen setting module 300A displays a user interface (for example, above-mentioned pen icons, or a menu screen for setting details of pen style), and sets a style of stroke drawing in accordance with the operation of the user interface by the user. In the embodiment, several pen icons, with which several representative pen styles are associated, are displayed on the note view screen. The pen icons include a black pen icon, a red pen icon, a green pen icon, a transparent pen icons, etc. The black pen icon is a pen icon for drawing a black solid line. The red pen icon is a pen icon for drawing a red solid line. The green pen icon is a pen icon for drawing a green solid line. The transparent pen icon is a pen icon with which a drawing style having an attribute of transparency is associated. The transparent pen icon is used, for example, to embed, in a handwritten page, a handwritten character or mark having an attribute (transparency attribute) with which the character or mark is not displayed on the screen. By utilizing the above-described handwriting search, the user can easily detect handwritten page data that includes a character, a mark, etc., handwritten by the transparent pen icon.

Upon receiving a “touch” (“tap”) event on one of the pen icons, the pen setting module 300A sets, as a current drawing style, a drawing style associated with the touched pen icon.

The background setting module 300B sets the style (page style) of the background of a handwriting-enabled page (handwriting page) displayed on the note view screen, in accordance with a background color setting operation by the user. The style of the background of the handwriting-enabled page includes a background color for the handwriting-enabled page, existence/non-existence of ruled lines displayed in the background of the handwriting-enabled page, the interval between the ruled lines displayed in the background of the handwriting-enabled page, and the like.

The display process module 301 and the time-series data generator 302 receive a “touch,” “move” (or “slide” or “release”) event generated by the touchscreen display 17, thereby detecting a handwriting input operation. The “touch” event includes the coordinates of the touch position. The “move” (“slide”) event includes the coordinates of the destination of the touch position. Thus, the display process module 301 and the time-series data generator 302 can have a coordinate string corresponding to the locus of movement of the touch position.

The display process module 301 displays the note view screen (handwriting page) in a background style (page style) set by the background setting module 300B. Further, the display process module 301 functions as a drawing unit configured to draw strokes (the loci of strokes) input by handwriting on the note view screen in a drawing style (including a color, a line type, etc.) set by the pen setting module 300A (color, line style, etc.).

That is, the display process module 301 receives a coordinate series from the touchscreen display 17. Based on the coordinate series, the display process module 301 draws, on the note view screen, the locus of each stroke handwritten by a handwriting input operation, in a drawing style (pen style) set by the pen setting module 300A. The display process module 301 displays, on the note view screen, the locus of the stylus 100 assumed while the stylus 100 is in contact with the screen, that is, the locus of each stroke.

The user can handwrite a character, a mark, a figure, etc., on the note view screen, using an arbitrary pen style (an arbitrary color, line type, etc.). However, if the set color of the pen is the same as the background color of the handwritten page, handwritten strokes are invisible.

For instance, there is a case where the user intentionally sets, for the pen, the same color as the background color, in order to embed, in a handwritten page, a handwritten character or mark that has a transparency attribute and is therefore not displayed on the screen. Also when the above-mentioned transparent pen icon is selected, the color of the pen is automatically set to the same color as the background color.

However, if the pen color is the same as the background color, the user cannot see handwritten strokes and hence cannot confirm handwritten strokes. Furthermore, since the strokes are invisible, they are hard to erase, using the erasure tool.

Therefore, the display process module 301 is configured to draw, on the screen, strokes input by handwriting, using a second color different from a certain set color (first color), if the certain set color (first color) is the same as the color of the background. The color of the background on the screen is, for example, the background color of a handwritten page set by the background setting module 300B. It should be noted here that another object, such as graphic data or image data, can be placed on a handwritten page, and a handwritten stroke can be drawn on the object. Accordingly, the above-mentioned color of the background on the screen may be the color of an object positioned on the screen behind the stroke, for example, the filling color of this object.

As the second color, the complementary color of the background color is used, for example. Further, if the set color (arbitrary first color) is the same as the color of the background on the screen, not only the color of strokes but also the line type, the line thickness, etc., of the strokes may be automatically changed.

In other words, when the set color (arbitrary first color) is the same as the color of the background on the screen, the pen display process module 301 can draw strokes input by handwriting in a preset pen style. As the preset pen style, a combination of the line type=a broken line, the line thickness=a thick line, and a color=the complementary color of the background can be used.

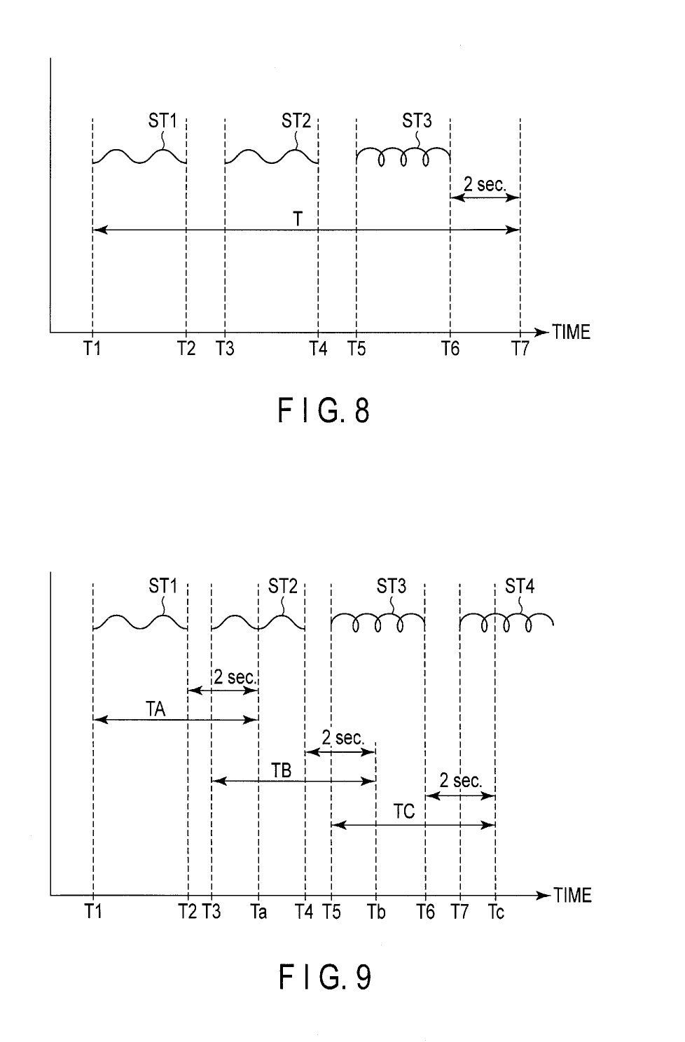

In addition, the display process module 301 is configured to automatically change the style of a respective stroke from the above-mentioned preset style to an originally set style, after the respective stroke is displayed in the above-mentioned preset style for a first period. In other words, after the first period elapses from the drawing of the stroke in a second color different from a set color (arbitrary first color), the display process module 301 draws (re-draws) the stroke on the screen, using the first color. The first period will be described later in detail with reference to FIGS. 8 and 9. The first period is not always a constant period, but may be a variable period that automatically varies in accordance with, for example, a handwriting operation by the user.

Thus, at least during the handwriting operation, the loci of strokes input by handwriting can be presented to the user in a visible manner, which enables the user to perform a handwriting input operation while seeing the screen. Further, after the first period has elapsed from drawing of a stroke in the above-mentioned preset style, the color of the stroke is automatically returned to the originally set color (first color). Thus, after the user has finished handwriting of a character or mark having a transparent attribute, the handwritten character or mark can be made invisible. This means that the inherent properties (that is, the transparent attribute) of the handwritten character or mark can be automatically recovered without any operation by the user.

Yet further, the display process module 301 can display, on the view screen, objects corresponding to various content data items (image data, audio data, text data, data generated by the drawing application) imported from an external application/external file by the import module 308. In this case, the objects corresponding to the content data items may be arranged in arbitrary positions on a currently generated page.

The time-sequence data generator 302 receives the above-mentioned coordinate series output from the touchscreen display 17, and generates, on the basis of the coordinate sequence, handwriting data. The handwriting data includes: time-series data (coordinate data series) having a structure as described in detail with reference to FIG. 4; pen style data indicative of a pen style set by the pen setting module 300; and page style data indicative of a page style set by the background setting module 300B. The time-sequence data generator 302 temporarily stores the generated handwriting data in a work memory 401.

As described above, in the embodiment, the color of each stroke drawn on the screen is temporarily changed to a visible color (second color). However, the pen style data (for example, data indicative of the color of the stroke) added to stroke data contained in generated handwriting data may not be changed.

The search/recognition processor 303 performs handwriting recognition processing of converting a handwritten character string in handwritten page data into a text (character code string), and character recognition processing (OCR) of converting a character string included in an image in the handwritten page data into a text (character code string). Furthermore, the search/recognition processor 303 can search for the above-mentioned handwriting search and text search.

The page storage module 306 generates handwritten page data including a plurality of types of content data (handwriting data, other various contents data item, etc.), and stores the handwritten page data in a storage medium 402. The storage medium 402 may be, for example, a storage device in the tablet computer 10, or a storage device in the server computer 2.

The page acquisition module 307 acquires arbitrary handwritten page data from the storage medium 402. The acquired handwritten page data is sent to the display process module 301. The display process module 301 displays, on the screen, a page in which a plurality of types of data (handwriting data, other content data) included in the handwritten page data are arranged.

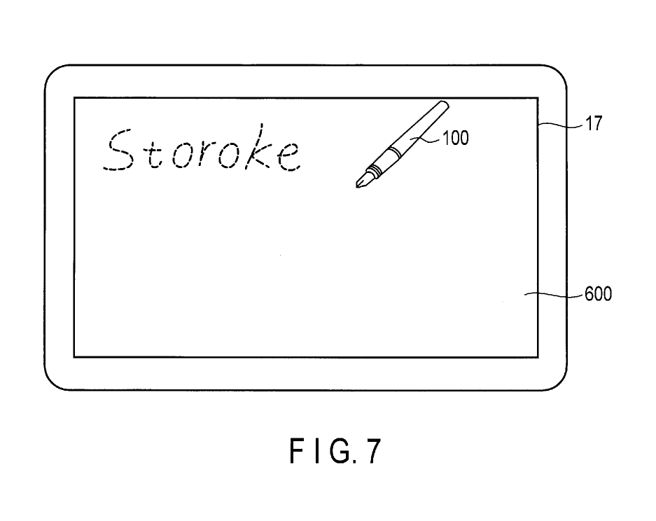

FIG. 7 shows an example of a drawing processing operation according to the embodiment.

A handwriting-enabled page 600 is displayed on the screen of the touchscreen display 17. In the shown case, it is assumed that the background color of the page 600 is set to green, and a green pen is selected by the user.

The display process module 301 determines that the color (in this case, green) for drawing strokes is the same as the background color of the handwritten possible page 600 (in this case, green). In processing for this determination, the display process module 301 may calculate the difference between the color for drawing and the background color, thereby determining that they are the same color, if the difference is not more than a threshold.

The display process module 301 draws on the page 600 a stroke input by handwriting in a preset pen style. In this case, the color of drawing is set to red as a complementary color of green. Further, the line type is set to “broken line,” and the line thickness is set to “thick.” Therefore, when, for example, a character string “storoke” is handwritten, the loci of strokes corresponding to the handwritten character string “storoke” are drawn on the screen in red using thick broken lines, with the background color set to green. The complementary color is a very visible color to the user. Further, as the style of strokes drawn in a normal handwriting input operation, a predetermined line type (solid line) and a predetermined thickness (of a predetermined point) are often used. Therefore, by drawing the locus of a stroke using a line of a line type, such as a broken line, or using a thick line, this stroke can be presented to the user, discriminated from other normal strokes, if any, drawn on the page 600 in various colors.

After a certain period elapses from the display of the handwritten string “storoke” by red, thick, broken lines, the display process module 301 automatically returns the color of handwritten string “storoke” to an original color (green). In other words, the display process module 301 draws (re-draws), on the screen in the original color (green), strokes corresponding to the handwritten character string “storoke,” after a first period elapses from the drawing of them on the screen by the red, thick, broken lines. Thus, the color of the handwritten string “storoke” is automatically returned to the original color (green).

FIG. 8 shows a first example of an operation of returning, to an original color, the color of strokes drawn in a color different from the background color.

In the shown case, it is assumed that a plurality of strokes have been continuously handwritten by the user in a state where the color (that is, the current pen color) of drawing the strokes is set to the same color as the background color. In this case, during a period in which the strokes are continuously handwritten, the strokes are being displayed in a color different from that of the current pen color (background color). When a certain time has elapsed after the completion of a series of handwriting input operations, the color of strokes on the screen is changed to the originally set color. In other words, these strokes are re-drawn on the screen in the original color.

That is, the above-mentioned first period, in which strokes input by handwriting are displayed in a color different from a set color (background color), with the color of drawing of strokes set to the same color as the background color, ranges from a time point corresponding to the start of drawing of the strokes in a second color, to a time point when stop of the handwriting input for a first reference time (for example, two seconds) or more is detected.

Assume here that as shown in FIG. 8, strokes ST1 to ST3 are continuously handwritten by the user in a state where the color of drawing the strokes is set to the same color as the background color, and thereafter stop of the handwriting input for two seconds or more is detected.

At time T1, drawing of stroke ST1 input by handwriting is started. Stroke ST1 is drawn in a second color different from the set color (first color). Drawing of stroke ST1 is completed at time T2. At time T3 less than 2 seconds after time T2, drawing of stroke ST2 input by handwriting is started. Stroke ST2 is drawn in the above-mentioned second color different from the set color (first color). Drawing of stroke ST2 is completed at time T4. At time T5 less than 2 seconds after time T4, drawing of stroke ST3 input by handwriting is started. Stroke ST3 is drawn in the above-mentioned second color different from the set color (first color). Drawing of stroke ST3 is completed at time T6.

After time T6, stop of the handwriting input for two seconds or more is detected by the display process module 301 at time T7. At this time, the color of strokes ST1 to ST3 on the screen is changed to the originally set color (first color). In other words, strokes ST1 to ST3 are re-drawn on the screen in the original color (first color). As a result, the color of strokes ST1 to ST3 on the screen is returned to the originally set color (first color) by the pen setting section 300A. In this case, the display process module 301 can re-draw strokes ST1 to ST3 on the screen in the original color (first color), in order to return the color of strokes ST1 to ST3 on the screen to the original color (first color), based on stroke data corresponding to strokes ST1 to ST3 and stored in the working memory 401.

In the example of FIG. 8, the minimum value of the aforementioned first period is two seconds. Further, the first period can be defined as a period in which each stroke is displayed in a color (second color) different from the current pen color (first color).

In this case, regarding stroke ST1, the first period, in which stroke ST1 is displayed in a color (second color) different from the current pen color (first color), corresponds to period T ranging from time T1 to time T7. Further, the first period, in which stroke ST2 is displayed in the color (second color) different from the current pen color (first color), corresponds to a period ranging from time T3 to time T7. Similarly, the first period, in which stroke ST3 is displayed in the second color, corresponds to a period ranging from time T5 to time T7.

Since the use of the operation described referring to FIG. 8 enables each stroke having the same color as the background color to be visibly displayed while the handwriting input operation is continuously performed, the operability can be enhanced.

Instead of immediately changing the color of each stroke from the second color to the original color (first color), the color of strokes may be gradually changed from the second color to the original color (first color). In this case, the strokes gradually disappear with lapse of time, which enables the user to beforehand know that each stroke will soon disappear. In order to gradually change the strokes from the second color to the original color (first color), the strokes may be continuously re-drawn using a plurality of different colors that fall within a color range of from the second color to the first color.

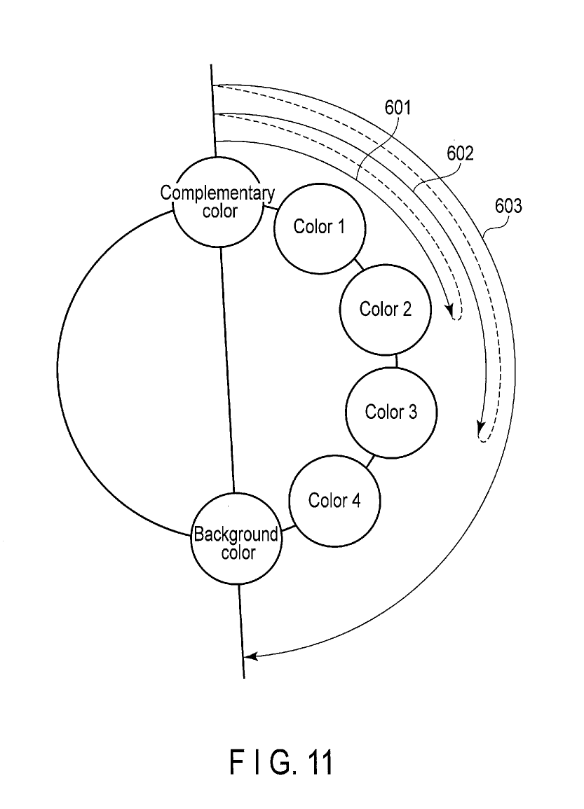

For instance, after time T6, when stop of the handwriting input for one second is detected, the display process module 301 can gradually change the color of stroke ST1 to ST3 from the second color (complementary color) to the original color (background color), as is indicated by solid line 601 or 602 in FIG. 11.

If the user resumes a handwriting input operation before time T7 in FIG. 8, that is, if a subsequent stroke is input by handwriting before stop of the handwriting input operation for a first reference time or more is detected, the period in which each of strokes ST1 to ST3 is displayed in a visible color is automatically extended. Further, the display process module 301 immediately returns, to the second color (complementary color), the current colors of strokes ST1 to ST3 that are already changed relatively close to the background color, as is indicated by the broken lines in FIG. 11. This enables the user to easily recognize that the period in which each stroke is displayed in a visible color has been extended.

In contrast, if the user does not resume the handwriting input operation before time T7 in FIG. 8, that is, if stop of the handwriting input operation for the first reference time or more is detected, the colors of strokes ST1 to ST3 are made identical to the background color at time T7 of FIG. 8.

FIG. 9 shows a second example of the operation of returning the color of each stroke, drawn in the second color different from the background color, to the original color (that is, the first color identical to the background color).

In the second example, it is assumed that strokes are continuously handwritten by the user in a state where the color (that is, the current pen color) of drawing the strokes is set to the same color as the background color. In this case, each stroke is continuously displayed in the second color until a first time (for example, two seconds) elapses after the drawing of this stroke is completed. When the time elapsing from the completion of the drawing of this stroke reaches the first time (for example, two seconds), the color of this stroke is returned to the original color. Namely, in the example of FIG. 9, the above-mentioned first period is a period until the first time (for example, two seconds) elapses after the start of drawing of the stroke in the second color. As described above, the first period can also be defined as the period in which each stroke is displayed in a color (second color) different from the current pen color (first color).

In this case, the above-mentioned first period is a period measured from a time point corresponding to the start of drawing a stroke in the second color, to a time point when an elapsed time from completion of drawing of the stroke reaches the first time (for example, two seconds).

Assume here that strokes ST1 to ST4 are continuously handwritten by the user in a state where the color of drawing the strokes is set to the same color as the background color, as is shown in FIG. 9.

At time T1, drawing of stroke ST1 input by handwriting is started. Stroke ST1 is drawn in the second color different from the set color (first color). Drawing of stroke ST1 is completed at time T2. At time T3 before two seconds elapse from time T2, drawing of stroke ST2 input by handwriting is started. Stroke ST2 is drawn in the second color different from the set color (first color). At time Ta two seconds after time T2, stroke ST1 is re-drawn in the first color, whereby the color of stroke ST1 is changed to the original color (the same color as the background color).

Drawing of stroke ST2 is completed at time T4. At time T5 before two seconds elapse from time T4, drawing of stroke ST3 input by handwriting is started. Stroke ST3 is drawn in the above-mentioned second color different from the set color (first color). At time Tb after two seconds elapses from time T4, stroke ST2 is re-drawn in the first color, whereby the color of stroke ST2 is changed to the original color.

Drawing of stroke ST3 is completed at time T6. At time T7 before two seconds elapse from time T6, drawing of stroke ST4 input by handwriting is started. Stroke ST4 is drawn in the above-mentioned second color different from the set color (first color). At time Tc after two seconds elapses from time T6, stroke ST3 is re-drawn in the first color, whereby the color of stroke ST3 is changed to the original color.

A period in which stroke ST1 is displayed in a color (second color) different from the current pen color (first color) is TA, a period in which stroke ST2 is displayed in a color (second color) different from the current pen color (first color) is TB, and a period in which stroke ST3 is displayed in a color (second color) different from the current pen color (first color) is TC.

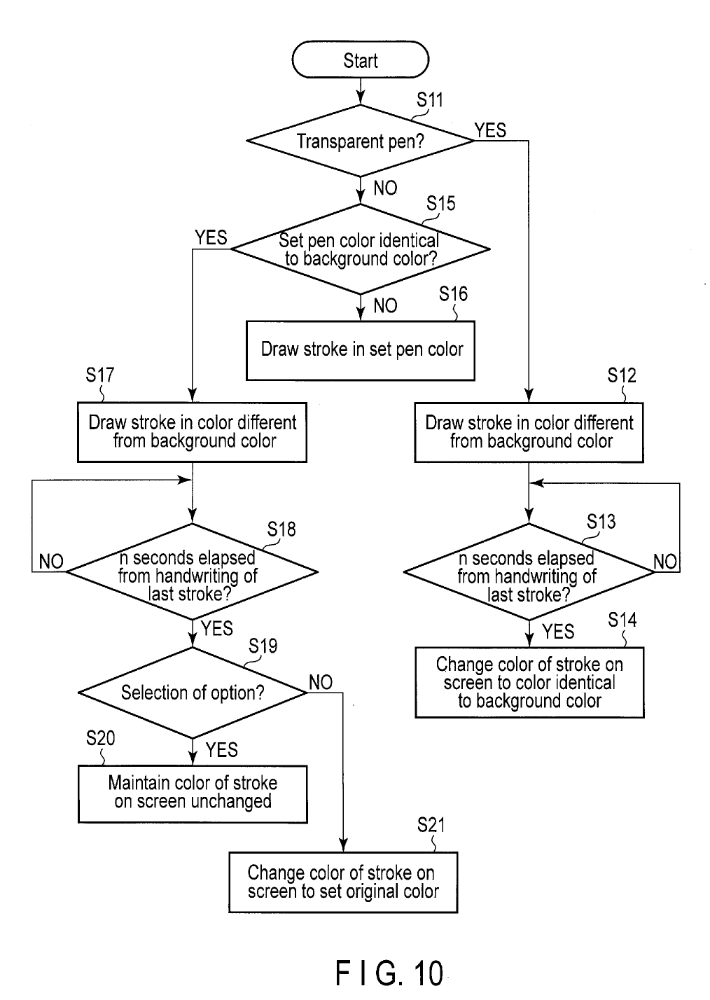

The flowchart of FIG. 10 shows a procedure of drawing processing performed by the digital notebook application program 202. It is assumed here that the operation described above with reference to FIG. 8 is performed, in order to return the color of the strokes on the screen to the original color.

The digital notebook application program 202 determines whether a current pen drawing style is a drawing style having transparency (transparent pen) (step S11).

If the current drawing style of the pen is the transparent pen (YES in step S11), the digital notebook application program 202 sets a color corresponding to the transparent pen, that is, a color identical to the current background color. The digital notebook application program 202 draws, on the screen, a stroke input by handwriting, using a color different from the background color, that is, using the above-mentioned preset pen style (color=the complementary color of the background color, line style=broken line, line thickness=thick) (step S12). As a result, the stroke is displayed on the screen in a color different from the background color.

When a plurality of strokes have been continuously handwritten by the user in a state where the current drawing style of the pen is set to the transparent pen, the strokes are drawn on the screen in the preset pen style. The digital notebook application program 202 measures the time elapsing from the completion of drawing of the last stroke, and determines whether a first reference time (in this example, n seconds) has elapsed from the completion of drawing of the last stroke, that is, whether the handwriting input stops for the first reference time or more (step S13).

If the stop of the handwriting input continues for n seconds after the completion of drawing of the last stroke, the digital notebook application program 202 determines that the first reference time (n seconds) has elapsed after the completion of drawing of the last stroke (YES in step S13). In this case, the digital notebook application program 202 re-draws the strokes, drawn in the predetermined pen style, on the screen in a drawing style corresponding to the transparent pen (step S14). In step S14, the color of the strokes drawn in the predetermined pen style is changed to the same color as the background color. As a result, the strokes become invisible.

If the current drawing style of the pen is not the transparent pen (NO in step S11), the digital notebook application program 202 determines whether the current pen color is the same as the current background color, based on a function associated with the difference between the current pen color and the current background color (step S15).

If it is determined that the current pen color is not the same as the current background color (NO in step S15), the digital notebook application program 202 draws the strokes, input by handwriting, on the screen in the current pen color (step S16).

In contrast, if it is determined that the current pen color is the same as the current background color (YES in step S15), the digital notebook application program 202 draws the strokes, input by handwriting, on the screen in a color different from the background color, that is, in the above-mentioned preset pen style (color=the complementary color of the background color, line style=broken line, line thickness=thick) (step S17). As a result, the strokes are displayed on the screen in a color different from the background color. When a plurality of strokes have been continuously handwritten by the user, they are drawn on the screen in the above-described preset pen style.

As described above, although the strokes are displayed visibly only in a certain period, they become invisible after the certain period.

Considering that the user may unintentionally select the same color as the background color, the digital notebook application program 202 may display, if necessary, an option menu on the screen to inquire whether the strokes should be maintained visible.

In this case, when the first reference time (in this case, n seconds) has elapsed after the completion of drawing of the last stroke (YES in step S18), the digital notebook application program 202 determines whether the user has selected that the strokes should be maintained visible (step S20). If it is selected that the strokes should be maintained visible (YES in step S19), the digital notebook application program 202 maintains the strokes visible, without changing the color of the strokes to the original color, that is, without re-drawing the strokes in the original color (step S20).

In contrast, if it is not selected that the strokes should be maintained visible (NO in step S19), the digital notebook application program 202 re-draws the strokes, drawn in the above-described preset pen style, on the screen in the set current pen style (in the current pen color) (step S21). As a result, the color of the strokes drawn in the above-mentioned predetermined pen style aforementioned screen is changed to the same color as the background color.

As described above, in the embodiment, if the color (arbitrary first color) set in accordance with the user interface is the same as the background color on the screen, a first stroke input by handwriting is drawn on the screen in a second color different from a set first color. After a first period elapses from the drawing of the first stroke in the second color, the first stroke is drawn on the screen in the first color. This structure enables the user to perform a handwriting input operation while seeing the screen, and enables the first stroke to be automatically invisible.

Therefore, it is not necessary to manually reset again and again the drawing color of a handwritten character, a handwritten mark, etc. Accordingly, a handwritten character, a handwritten mark, etc., which have a transparent attribute, can be easily embedded, thereby enhancing the operability of handwriting data.

Although the embodiment is mainly directed to a case where the background color is that of a handwritten page, the background color may be the color of an object that exists on the screen behind a stroke, for example, the filling color of the object, as described above.

Further, since various types of processing in the embodiment can be realized by a computer program, an advantage similar to that of the embodiment can be obtained simply by installing the computer program in a computer through a computer-readable storage medium storing the computer program, and executing the program.

The above-described embodiments are presented just as examples, and are not intended to limit the scope of the invention. The embodiments may be modified in various ways without departing from the scope. For instance, various omissions, replacements, changes, etc., may be made. These embodiments and their modifications are included in the inventions recited in the claims and the equivalents of the inventions.

What is claimed is:

1. An electronic device comprising a processor configured to:
set a first color for drawing strokes based on an operation of a user interface;
draw a first stroke, in response to handwriting input on a screen, in a second color different from the first color when the first color is identical to a color of a background on the screen; and
draw the first stroke on the screen in the first color when a first time period associated with drawing the first stroke in the second color elapses.

2. The electronic device of claim 1, wherein the first stroke in the second color is drawn using a first type of line or a first thick line.

3. The electronic device of claim 1, wherein a length of the first time period is from a point in time corresponding to the start of drawing the first stroke in the second color to a point in time subsequent to when the handwriting input ceases.

4. The electronic device of claim 1, wherein a length of the first time period is from a point in time corresponding to the start of drawing the first stroke in the second color to a point in time subsequent to when drawing of the first stroke is completed.

5. The electronic device of claim 1, wherein the processor is further configured to:
draw a second stroke on the screen in the second color when the handwriting input corresponding to the second stroke starts before a threshold time period elapses from a time of completion of drawing the first stroke in the second color; and
draw the first and second strokes on the screen in the first color when no handwriting input is detected for more than the threshold time period after the completion of drawing the second stroke in the second color.

6. The electronic device of claim 1, wherein the processor is further configured to gradually change the color of the first stroke on the screen from the second color to the first color when a second time period shorter than the first period elapses.

7. The electronic device of claim 3, wherein the processor is further configured to:
gradually change the color of the first stroke on the screen from the second color to the first color when no handwriting input is detected for a second time period shorter than the first time period; and
change the color of the first stroke on the screen to the first color when handwriting input corresponding a second stroke is received before the second time period elapses.

8. The electronic device of claim 1, wherein the color of the background is the background color of a handwriting-enabled page displayed on the screen.

9. The electronic device of claim 1, wherein when a transparent drawing style is selected designated, the processor is further configured to set a color for drawing strokes corresponding to handwriting input to the color of the background on the screen.

10. A method executed by an electronic device, the method comprising:
setting a first color for drawing strokes based on an operation of a user interface;
drawing a first stroke in response to handwriting input on a screen in a second color different from the first color, when the first color is identical to a color of a background on the screen; and
drawing the first stroke on the screen in the first color when a first time period associated with drawing the first stroke in the second color elapses.

11. A non-transitory computer-readable storage medium having stored thereon a computer program which is executable by a computer, the computer program controlling the computer to execute a function of:
setting a first color for drawing strokes based on an operation of a user interface;
drawing a first stroke in response to handwriting input on a screen in a second color different from a first color, when the first color is identical to a color of a background on the screen; and
drawing the first stroke on the screen in the first color when a first time period associated with drawing the first stroke in the second color elapses.
